(19) United States
(12) Patent Application Publication
(10) Pub. No.: US 2015/0004477 A1
(43) Pub. Date: Jan. 1, 2015

(54) SECONDARY BATTERY

(71) Applicant: SAMSUNG SDI CO., LTD., Yongin-si (KR)

(72) Inventors: Jake Kim, Yongin-si (KR); Jee-Won Kang, Yongin-si (KR); Seon-Hong Lee, Yongin-si (KR); Jong-Man Kim, Yongin-si (KR); Jee-Hoon Han, Yongin-si (KR); Young-Woong Kwan, Yongin-si (KR); Hee-Sung Choi, Yongin-si (KR); Byong-Gon Lee, Yongin-si (KR); Maeng-Eun Lee, Yongin-si (KR)

(21) Appl. No.: 14/306,171

(22) Filed: Jun. 16, 2014

(30) Foreign Application Priority Data
Jun. 27, 2013 (KR) 10-2013-0074272

(51) Int. Cl. H01M 2/22; H01M 2/04

(52) U.S. Cl. CPC H01M 2/22; H01M 2/04
USPC 429/178

(57) ABSTRACT

A secondary battery includes an electrolyte; an electrode assembly including: a first electrode plate including a first active material on a first base material, a second electrode plate opposite to the first electrode plate and including a second active material on a second base material, and a separator between the first and second electrode plates; a battery case accommodating the electrode assembly and the electrolyte; and a bridge member coupled between terminal portions having different polarities at the outside of the battery case, wherein the voltage of the secondary battery is −0.1V to 0.1V.

### CROSS-REFERENCE TO RELATED APPLICATION

This application claims priority to and the benefit of Korean Patent Application No. 10-2013-0074272, filed on Jun. 27, 2013, in the Korean Intellectual Property Office, the entire contents of which are incorporated herein by reference in their entirety.

### BACKGROUND

1. Field

Embodiments of the present invention relates to a secondary battery.

2. Description of the Related Art

In general, a secondary battery is a battery which can be charged and discharged multiple times. As electronic, communication, and computer industries are developed, consumer demand for secondary batteries easily employed as power sources for portable devices has recently increased. As the type and amount of secondary batteries used increases, studies have been conducted in many fields in order to improve the performance and safety of the secondary batteries.

As demands on secondary batteries increases, studies have been conducted in many fields to efficiently manufacture secondary batteries. On the other hand, a lithium compound included in the secondary battery has a very large reactivity, which may increase a risk of manufacturing defects such as a short circuit. Hence, it is not easy to change the manufacturing process of the secondary battery. Accordingly, studies have been conducted in many fields to simplify the manufacturing process of the secondary battery while maintaining the safety and reliability of the secondary battery, thereby improving the productivity of the secondary battery.

### SUMMARY

Embodiments provide a secondary battery having an improved design.

Embodiments also provide a secondary battery having improved productivity by omitting formation.

According to an embodiment of the present invention, there is provided a secondary battery including: an electrolyte; an electrode assembly including: a first electrode plate including a first active material on a first base material, a second electrode plate opposite to the first electrode plate and including a second active material on a second base material, and a separator between the first and second electrode plates; a battery case accommodating the electrode assembly and the electrolyte; and a bridge member coupled between terminal portions having different polarities at the outside of the battery case, wherein a voltage of the secondary battery is in a range of −0.1V to 0.1V.

The first base material may include aluminum, and a potential of the first electrode plate may be no less than a reductive potential of aluminum oxide.

The potential of the first electrode plate may be no less than 2.0V, and the potential of the second electrode plate may be no more than 3.3V.

The second base material may include copper, and a potential of the second electrode plate may be no more than an elution potential of the copper.

The first electrode plate may have a first electrode tab, and the second electrode plate may have a second electrode tab, and the first and second electrode tabs may extend outside the electrode assembly.

The first and second electrode tabs may extend in parallel to each other from the electrode assembly to outside of the battery case, and the bridge member may have first and second connecting portions respectively coupled to the first and second electrode tabs.

The battery case may include a first terminal portion electrically coupled to the first electrode tab, and a second terminal portion electrically coupled to the second electrode tab, the second terminal portion being electrically insulated within the battery case from the first terminal portion, and the bridge member may have first and second connecting portions respectively coupled to the first and second terminal portions.

The bridge member may include the first and second connecting portions, and a body portion configured to couple the first and second connecting portions therethrough.

The body portion may include a conducting portion electrically coupled to the first and second connecting portions, and an insulating portion around the conducting portion.

The first and second connecting portions and the conducting portion may include copper or aluminum.

The battery case may include a housing configured to accommodate the electrode assembly and the electrolyte through one opened surface thereof, and a cap assembly configured to cover the one opened surface of the housing.

The secondary battery may further include a top portion mounted on the cap assembly and configured to surround the bridge member.

The top portion may include a base portion formed in a shape corresponding to the cap assembly, and a flange portion extended toward the cap assembly from an outer circumference of the base portion.

The top portion may have a cavity defined by the base portion and the flange portion, and the bridge member may be inserted into the cavity.

The bridge member may include a body portion formed in a reverse U shape, and first and second connecting portions respectively located at opposite ends of the reverse U shape.

The top portion may be made of an insulator, and the body portion may be made of a conductor to be inserted into the cavity of the top portion.

The flange portion may include a first fastening portion, and the battery case may include a second fastening portion configured to be coupled to the first fastening portion.

The bridge member may include sequentially laminated conductive, adhesive, and resin layers, and the conductive layer may have an area smaller than that of each of the adhesive and resin layers.

The conductive layer may couple terminal portions having different polarities at the outside of the battery case, and the adhesive layer may be attached to an outer surface of the battery case.

A shape of the bridge member may be elastically changeable.

As described above, it is possible to provide a secondary battery having a new member that may extend outside of the battery case to couple opposite polarity electrodes.

Further, it is possible to provide a secondary battery having improved productivity by reducing manufacturing steps (e.g., omitting formation).

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it may be the only element between the two elements, or one or more intervening elements may also be present. Like reference numerals refer to like elements throughout.

FIG. 1 is a perspective view of a secondary battery according to an embodiment of the present invention.

FIG. 2 is an exploded perspective view of the secondary battery of FIG. 1.

FIG. 3 is an exploded perspective view of an electrode assembly of FIG. 2.

FIG. 4A is a perspective view of a bridge member of FIG. 2.

FIG. 4B is a sectional view taken along the line II-II′ of the bridge member of FIG. 4A.

FIG. 5 is a sectional view taken along the line I-I′ of the secondary battery of FIG. 1.

FIG. 6 is a sectional view of a secondary battery according to another embodiment of the present invention.

FIG. 7 is a sectional view of a secondary battery according to still another embodiment of the present invention.

FIG. 8 is a perspective view of a secondary battery according to still another embodiment of the present invention.

FIG. 9 is an exploded perspective view of the secondary battery of FIG. 8.

FIG. 10 is a perspective view showing a top portion and a bridge member, shown in FIG. 9.

FIG. 11 is a perspective view of a secondary battery according to still another embodiment of the present invention.

FIG. 12 is a perspective view of a bridge member of FIG. 11.

FIG. 13 is a sectional view taken along the line III-III′ of the bridge member of FIG. 12.

FIG. 14 is a graph showing potentials of first and second electrode plates and secondary batteries.

FIG. 15A is a scanning electron microscope (SEM) photograph of a second electrode plate according to an embodiment of the present invention.

FIG. 15B is an SEM photograph of a second electrode plate according to a comparative example.

FIG. 16 is a graph showing open circuit voltages (OCVs) of first and second electrode plates of a secondary battery with respect to time according to the embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” or “coupled to” another element, it can be directly connected to the another element or be indirectly connected to the another element with one or more intervening elements interposed therebetween. Hereinafter, like reference numerals refer to like elements.

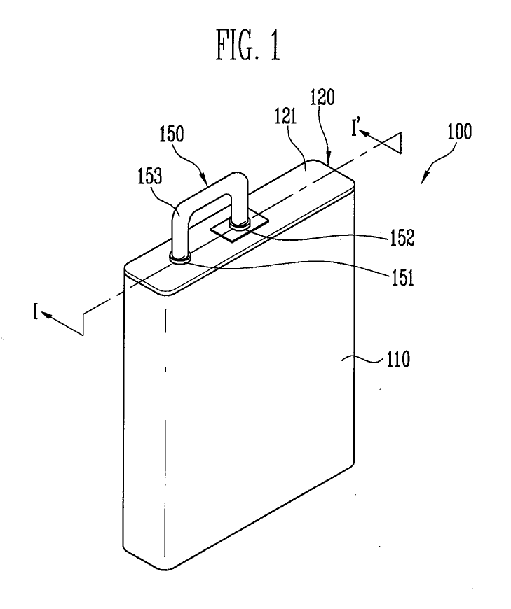

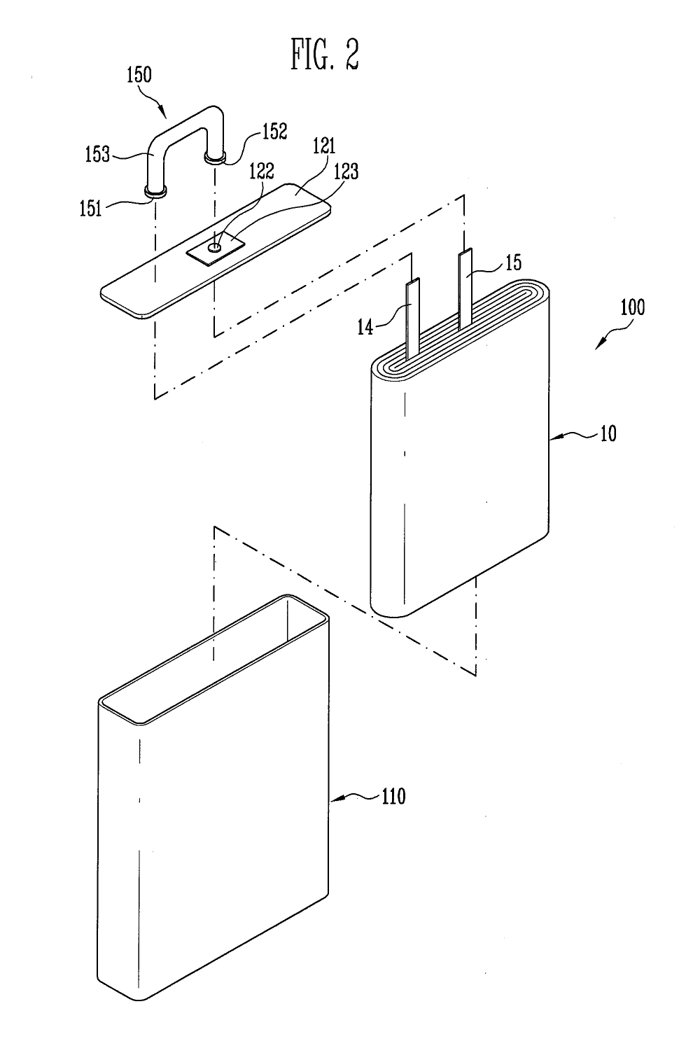

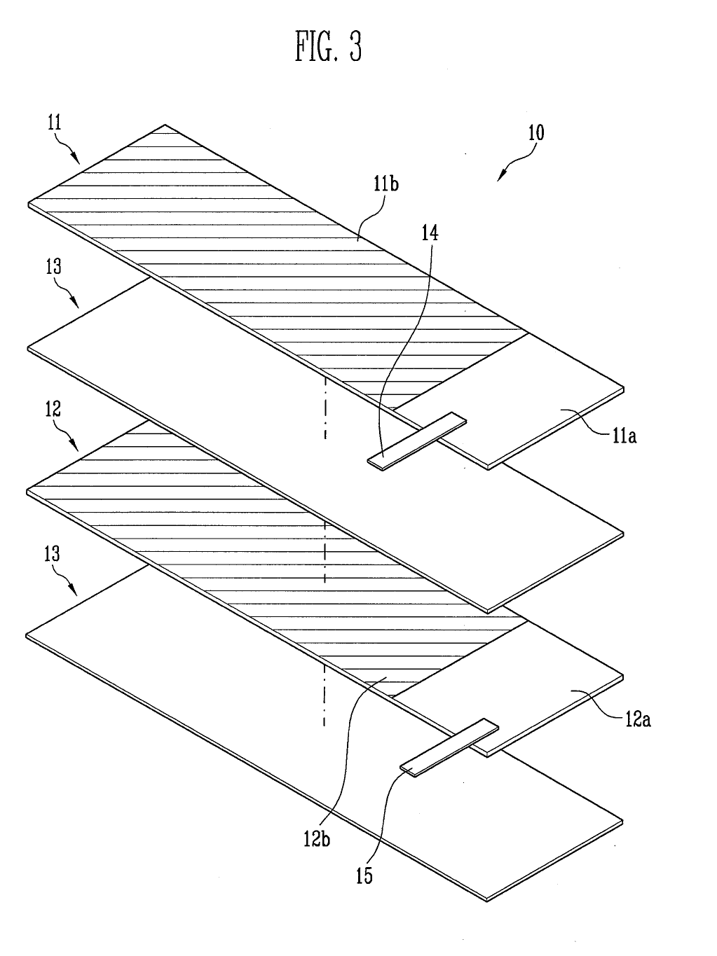

FIG. 1 is a perspective view of a secondary battery according to an embodiment of the present invention. FIG. 2 is an exploded perspective view of the secondary battery of FIG. 1. FIG. 3 is an exploded perspective view of an electrode assembly of FIG. 2.

Referring to FIGS. 1 to 3, the secondary battery 100 according to this embodiment includes an electrolyte; an electrode assembly 10 including a first electrode plate 11 formed by coating a first active material 11b on a first base material 11a, a second electrode plate 12 formed by coating a second active material 12b on a second base material, and a separator 13 interposed between the first and second electrode plates 11 and 12; a battery case 110 and 120 configured to accommodate the electrode assembly 10 and the electrolyte therein; and a bridge member 150 configured to couple terminal portions 121 and 122 having different polarities at the outside of the battery case 110 and 120. The secondary battery 100 may have a voltage of −0.1V to 0.1V.

The secondary battery 100 may be formed by accommodating the electrode assembly 10 and the electrolyte in the battery case 110 and 120. Here, the electrode assembly 10 includes the first and second electrode plates 11 and 12 having different polarities, and the separator 13 is provided to prevent the first and second electrode plates 11 and 12 from being short-circuited by coming in direct contact with each other. The electrolyte enables ions to move between the first and second electrode plates 11 and 12. The electrode assembly 10 may be formed in a jelly roll (J/R) shape by winding or rolling the first and second electrode plates 11 and 12 and the separator 13, which are stacked with one another. Alternatively, the electrode assembly 10 may be formed in a stack shape by stacking a plurality of first and second electrode plates 11 and 12 and a plurality of separators 13. Alternatively, the electrode assembly 10 may be formed using both the winding and stacking processes. According to embodiments of the present invention, the electrode assembly 10 may be formed in various shapes. However, the electrode assembly 10 formed in the jelly-roll shape will be mainly described hereinbelow.

The first electrode plate 11 may be formed by coating (e.g., intermittently coating) the first active material 11b on the first base material 11a. A first electrode tab 14 made of a conductive material or metal such as nickel may be provided at a portion where the first base material 11a is exposed. For example, the first electrode plate 11 may be a positive electrode plate, and the first active material 11b may be a positive electrode active material including lithium.

The second electrode plate 12 has a polarity different from that of the first electrode plate 11. The second electrode plate 12 may be formed by coating (e.g., intermittently coating) the second active material 12b on the second base material 12a. A second electrode tab 15 made of a conductive material or metal such as nickel may be provided at a portion where the second base material 12a is exposed. For example, the second electrode plate 12 may be a negative electrode plate, and the second active material 12b may be a negative electrode active material including carbon.

The first or second base materials 11a and 12a act as a collector of current or electrons, and may include a thin-film-shaped conductive material or metal. For example, the first base material 11a may include aluminum, and the second base material 12a may include copper. The first and second electrode plates 11 and 12 generate the flow of current or electrons by discharging ions into the electrolyte, and the current or electrons are transferred to the outside of the electrode assembly 10 through the first and second electrode tabs 14 and 15. The first electrode tab 14 may be a positive electrode tab, and the second electrode tab 15 may be a negative electrode tab.

The electrolyte may be provided to facilitate the movement of ions or electric charges between the first and second electrode plates 11 and 12. The electrolyte may include a lithium salt that acts as a supply source of lithium ions, and a non-aqueous organic solvent that serves as a medium through which ions participating in an electrochemical reaction can be moved.

In the electrode assembly 10, the first and second electrode tabs 14 and 15 may extend outside of the electrode assembly 10. The battery case 110 and 120 may include a can or housing 110 configured to have one opened surface so as to accommodate the electrode assembly 10 and the electrolyte therein, and a cap assembly 120 configured to cover the one surface of the can 110. The battery case 110 and 120 includes a first terminal portion 121 electrically coupled to the first electrode tab 14, and a second terminal portion 122 electrically coupled to the second electrode tab 15. The second terminal portion 122 is electrically insulated from the first terminal portion 121. The bridge member 150 is coupled to each of the first and second terminal portions 121 and 122 so that the secondary battery 100 may be short-circuited at the outside thereof. In this case, the bridge member 150 includes first and second connecting portions 151 and 152, and the first and second connecting portions 151 and 152 may be respectively coupled to the first and second terminal portions 121 and 122 by, for example, a method such as welding.

The can 110 may be formed, for example, in a box shape having one opened surface, and the cap assembly 10 may be made of a conductive material such as metal. In this case, the cap assembly 120 may be formed as a conductive metal plate corresponding to the one surface of the can 110. The metal plate may have a hole formed therein so that a negative pin passes through the hole, and a gasket may be provided between the metal plate and the negative pin. The metal plate may be coupled to the first electrode tab 14 to act as the first terminal portion 121, and the negative pin may be coupled to the second electrode tab 15 to act as the second terminal portion 122. The gasket may be a gasket 123 provided around the second terminal portion 122 as the negative pin to allow the first and second terminal portions 121 and 122 to be electrically insulated from each other. In this embodiment, the secondary battery 100 may be a prismatic secondary battery.

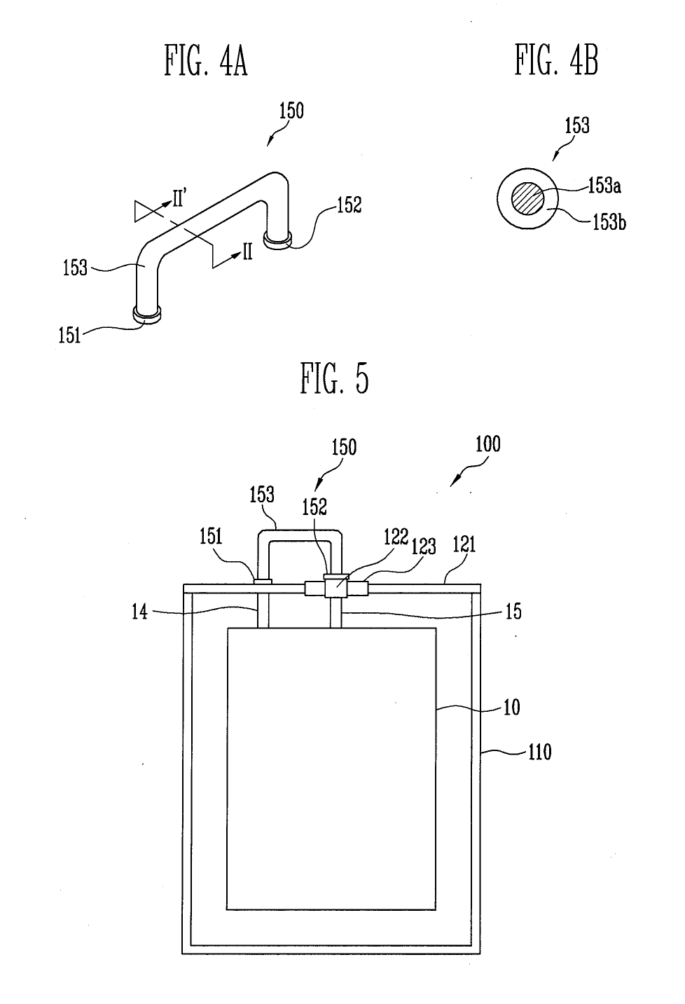

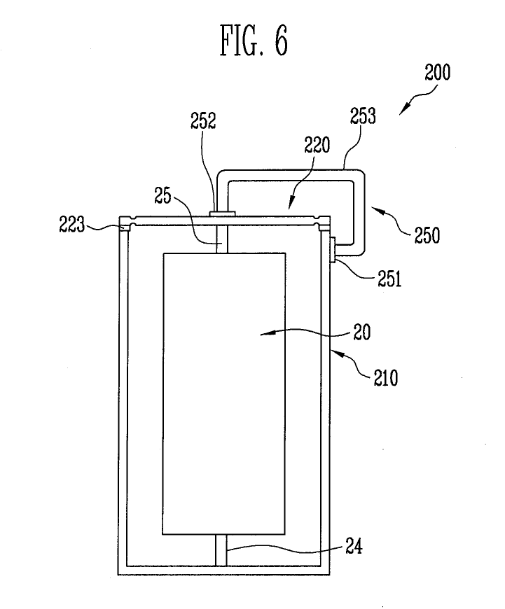

FIG. 4A is a perspective view of the bridge member of FIG. 2. FIG. 4B is a sectional view taken along the line II-II′ of the bridge member of FIG. 4A. FIG. 5 is a sectional view taken along the line I-I′ of the secondary battery of FIG. 1.

Referring to FIGS. 4A and 4B, the secondary battery according to this embodiment may further include a bridge member 150. The bridge member 150 may be coupled to an outer surface of the battery case. The bridge member 150 may include first and second connecting portions 151 and 152, and a body portion 153 configured to couple the first and second connecting portions 151 and 152 therethrough. The body portion 153 may include a conducting portion 153a electrically coupled to the first and second connecting portions 151 and 152, and an insulating portion 153b configured to surround an outer surface of the conducting portion 153. For example, the first and second connecting portions 151 and 152 and the conducting portion 153a may copper or aluminum, and the insulating portion 153b may be made of an insulator such as polymer resin. In the bridge member 150, the first and second connecting portions 151 and 152 and the conducting portion 153a are electrically coupled to each other. For example, the first and second connecting portions 151 and 152 and the conducting portion 153a may be made of the same material. The first and second connecting portions 151 and 152 may be coupled to an outer surface of the battery case through welding or the like. On the other hand, because the insulating portion 153b is made of an insulator, the insulating portion 153b can protect the conducting portion 153a by covering the conducting portion 153a which is easily exposed to the outside. The bridge member 150 may be provided so that the shape of the bridge member 150 is elastically changeable. For example, the shape of the body portion 153 may be variously changed depending on positions at which the first and second connecting portions 151 and 152 are provided.

Referring to FIG. 5, the bridge member 150 is provided at an outer surface of the secondary battery 100. In this case, the first connecting portion 151 of the bridge member 150 may be coupled to the first terminal portion 121, and the second connecting portion 152 of the bridge member 150 may be coupled to the second terminal portion 122. The first and second electrode tabs 14 and 15 having different polarities are electrically coupled to the respective first and second terminal portions 121 and 122, so that the first and second terminal portions 121 and 122 can also be provided to have different polarities. In this case, the gasket 123 is interposed between the first and second terminal portions 121 and 122, so that it is possible to prevent the first and second terminal portions 121 and 122 from being electrically short-circuited with each other.

On the other hand, the bridge member 150 allows the first and second terminal portions 121 and 122 having different polarities to be electrically coupled therethrough, so that an external short circuit can be induced. Thus, it is possible to prevent or reduce metal in the first or second plate from being corroded due to elution of the metal. That is, in the secondary battery 100 according to this embodiment, the external short circuit can be maintained by the bridge member 150. Thus, the potential of the first electrode plate can be maintained higher than the reductive potential of the metal constituting the first base material, and the potential of the second electrode plate can be maintained lower than the elution potential of the metal constituting the second base material, thereby preventing or reducing degradation of the secondary battery 100, caused by corrosion of the first and second materials, etc. Accordingly, in the secondary battery 100 according to this embodiment, it is possible to omit formation that is a process for preventing or reducing metal in the first or second electrode plate from being eluted in the related art secondary battery, thereby improving process efficiency.

The secondary battery 100 may be manufactured in a state in which the secondary battery 100 is not charged. Therefore, the secondary battery 100 may have a voltage of about 0V. The secondary battery 100 may be released from a factory in a state in which a solid electrode interface (SEI) film is not formed on both the first and second electrode plates. Therefore, in the secondary battery 100, the first or second electrode plate, specifically, the first or second active material provided in the first or second electrode plate may come in direct contact with the separator in the state in which the SEI film is not formed on the first or second electrode plate. On the other hand, the voltage of the secondary battery 100 may be measured as −0.1V to 0.1V due to a measurer that measures the voltage of the secondary battery 100. The secondary battery 100 released as described above may be used as a power source after the bridge member 150 is removed from the secondary battery 100 before the secondary battery 100 is employed in an external electronic device. A charging/discharging pattern for initially charging the secondary battery 100 is built in the external electronic device, and the secondary battery 100 is initially charged by current supplied from the external electronic device, so that an SEI film or the like can be formed on the first or second electrode plate. The SEI film may be formed through a reaction between the second active material and the electrolyte by supplying current to the second battery. Thus, the secondary battery in which the SEI film is formed by the initial charging can prevent or reduce a metal such as copper constituting the second base material from being eluted into the electrolyte. Accordingly, the secondary battery can be charged/discharged multiple times without using the bridge member any more.

Generally, a secondary battery of which assembling has been completed by accommodating an electrolyte and an electrode assembly in a battery case passes through formation. The formation includes various steps including a step of maintaining the secondary battery at a normal temperature during which the first and second electrode plates are immersed in the electrolyte, a charging/discharging step for forming an SEI film on the first or second electrode plate, e.g., a surface of the second electrode plate that is a negative electrode plate, a step of maintaining the secondary battery at a high temperature so as to improve the reliability of the secondary battery, and the like. In this case, the SEI film is provided to prevent or reduce the elution of metal constituting a second base material, e.g., copper. The formation process may occur over the course of 10 to 20 days, and may further include the use of various associated facilities such as a charging/discharging device and a high-temperature space for leaving the secondary battery. This increases the manufacturing time and cost of the secondary battery and decreases the productivity of the secondary battery.

In the secondary battery according to the present invention, the formation including multiple steps can be omitted, and the assembled secondary battery can be sold to customers much more quickly (e.g., immediately after manufacturing). Thus, the production of the secondary battery can be completed through only assembling, so that the time required to perform the formation can be omitted, thereby improving the productivity and efficiency of manufacturing of the secondary battery. Further, various associated costs (e.g., equipment and facilities, and charging/discharging devices) for performing the formation, are unnecessary, thereby reducing production cost.

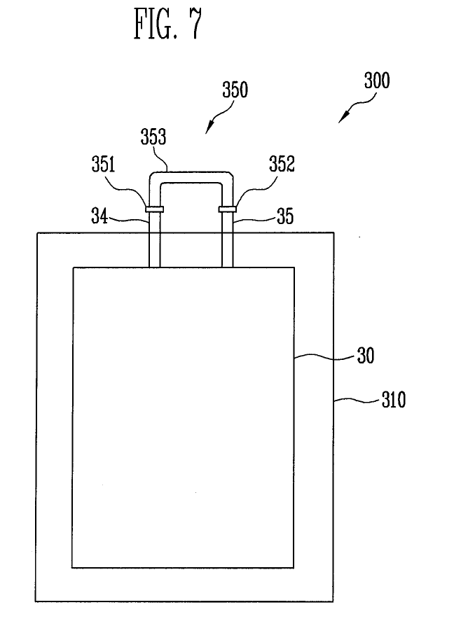

Hereinafter, other embodiments of the present invention will be described with reference to FIGS. 6 to 13. Contents of these embodiments, except the following contents, are similar to those of the embodiment described with reference to FIGS. 1 to 5, and therefore, their detailed descriptions will be omitted.

FIG. 6 is a sectional view of a secondary battery according to another embodiment of the present invention.

Referring to FIG. 6, the secondary battery 200 according to this embodiment includes a battery case 210 and 220, and an electrode assembly 20 accommodated in the battery case 210 and 220. The secondary battery 200 may have a voltage of −0.1V to 0.1V. The electrode assembly 20 may be formed by winding or rolling, in a jelly-roll shape, first and second electrode plates and a separator interposed between the first and second electrode plates. The first and second electrode plates may have different polarities, and first and second electrode tabs 24 and 25 may be provided to the respective first and second electrode plates. The battery case 210 and 220 may include a cylindrical can or housing 210 made of iron or the like to accommodate the electrode assembly 20 therein, and a cap assembly 220 configured to hermetically seal one surface of the can 210. The first electrode tab 24 may extend toward a bottom surface of the can 210 from electrode assembly 20 so as to be electrically coupled to the can 210, and the second electrode tab 25 may extend upward from the electrode assembly 20 so as to be electrically coupled to the cap assembly 220. The cap assembly 220 may include a plate-shaped metal and one or more safety members provided to the plate-shaped metal. The cap assembly 220 may be coupled to the second electrode tab 25 at an inner lower portion thereof so as to act as a second terminal portion. An insulator such as a gasket may be interposed between the can 210 and the cap assembly 220, to allow the can 210 and the cap assembly 220 to be insulated from each other. In the battery case 210 and 220, the can 210 coupled to the first electrode tab 24 may be, for example, a first terminal portion, and the portion of the cap assembly 220, coupled to the second electrode tab 25, may be a second terminal portion having a polarity different from that of the first terminal portion. In the secondary battery 200, the arrangement, configuration, or shape of battery case 210 and 220 may be variously modified, and the present invention is not limited thereto.

The secondary battery 200 may further include a bridge member 250 configured to allow the first and second terminal portions to be short-circuited with each other at the outside of the secondary battery 200. The bridge member 250 may include a first connecting portion 251 electrically coupled to the first terminal portion, and a second connecting portion 252 electrically coupled to the second terminal portion. In the bridge member 250, the first and second connecting portions 251 and 252 are electrically coupled by a body portion 253, and thus an external short circuit of the secondary battery can be induced. The voltage of the secondary battery 200 may be −0.1V to 0.1V, and the manufacturing of the secondary battery 200 may be completed by omitting formation. Accordingly, the first and second electrode plates of the secondary battery 200 may exist in a state in which an SEI film is not formed on the first and second electrode plates.

In the bridge member 250 according to this embodiment, an inside of the body portion 253 coupling the first and second connecting portions 251 and 252 may be bent. The body portion 253 may be freely modified according to the positions of the first and second terminal portions to which the respective first and second connecting portions 251 and 252 are coupled. That is, the body portion 253 may be made of a material of which the shape can be elastically changed, and thus the bridge member 250 is applicable, regardless of the external appearance, configuration, or shape of the secondary battery 200.

FIG. 7 is a sectional view of a secondary battery according to still another embodiment of the present invention.

Referring to FIG. 7, the secondary battery 300 according to this embodiment may include a pouch-type battery case 310 and an electrode assembly 30 accommodated inside the battery case 310. The electrode assembly 30 may be provided with first and second electrode tabs 34 and 35 having different polarities. A bridge member 350 configured to induce an external short circuit of the secondary battery 300 may be provided at the outside of the battery case 310.

The first and second electrode tabs 34 and 35 may extend parallel to each other from the electrode assembly 20 and outside of the battery case 310. The bridge member 350 may include first and second connecting portions 351 and 352 respectively coupled to the first and second electrode tabs 34 and 35. The bridge member 350 may further include a body portion 353 configured to couple the first and second connecting portions 351 and 352 therethrough. The first and second connecting portions 351 and 352 are conductive, and may be coupled by the body portion 353. A conducting portion is provided inside the body portion 353 so that the first and second connecting portions 351 and 352 can be electrically coupled therethrough, and an insulating portion configured to surround the conducting portion is provided outside the body portion 353 so that it is possible to prevent the conducting portion from being exposed to the outside of the body portion 353. When the secondary battery 300 is manufactured, formation may be omitted, and the secondary battery 300 having the bridge member 350 may be released. The secondary battery 300 may have a voltage of approximately 0V. The voltage of the secondary battery 300 may be measured as −0.1V to 0.1V according to an error of a device for measuring voltage.

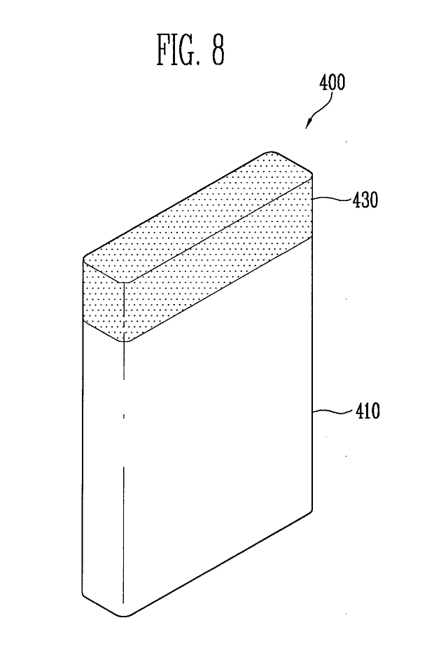

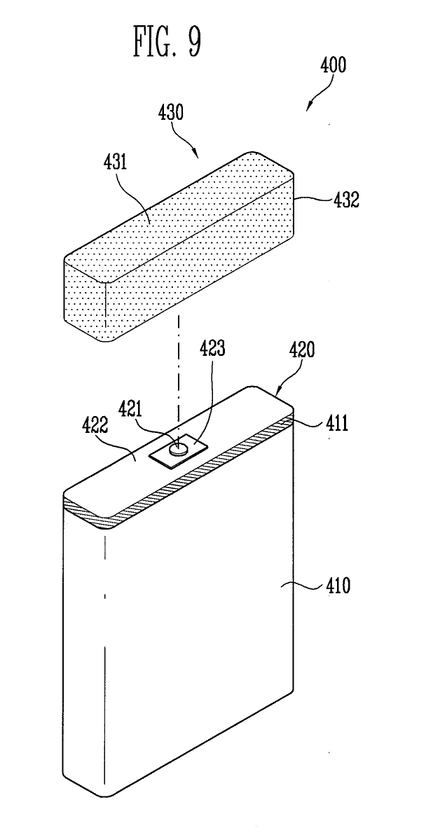

FIG. 8 is a perspective view of a secondary battery according to still another embodiment of the present invention. FIG. 9 is an exploded perspective view of the secondary battery of FIG. 8. FIG. 10 is a perspective view showing a top portion and a bridge member, shown in FIG. 9.

Referring to FIGS. 8 to 10, the secondary battery 400 according to this embodiment may include a battery case 410 and 420, and an electrode assembly accommodated in the battery case 410 and 420. Here, the battery case 410 and 420 includes a can 410 and a cap assembly 420 configured to hermetically seal the can 410. The secondary battery 400 may further include a top portion 430 mounted on the cap assembly 420. The top portion 430 may have a bridge member 450 therein. The portion of the electrode assembly, coupled to a first electrode tab, may be a first terminal portion 421, and the portion of the electrode assembly, coupled to a second electrode tab having a polarity different from that of the first electrode tab, may be a second terminal portion 422. The first and second terminal portions 412 and 422 may be insulated from each other by a gasket 423. The first and second terminal portions 421 and 422 are electrically coupled by the bridge member 450, and the bridge member 450 may induce an external short circuit of the secondary battery 400.

The top portion 430 may include a base portion 431 formed in a shape corresponding to the cap assembly 420, and a flange portion 432 extended toward the cap assembly 420 from the outer circumference of the base portion 431. The top portion 430 has a space portion or cavity 433 defined by the base portion 431 and the flange portion 432, and the bridge member 450 may be inserted into the space portion 433. The top portion 430 may be formed by molding polymer resin, using a mold or the like.

The bridge member 450 may include a body portion 453 formed in a reverse U shape, and first and second connecting portions 451 and 452 respectively provided at one end and the other end of the reverse U shape. The top portion 430 may be made of an insulator, and the body portion 453 may be made of a conductor to be inserted in the space portion 433 of the top portion 430. The body portion 453 may electrically couple the first and second connecting portions 451 and 452 therethrough, and the body portion 453 and the first and second connecting portions 451 and 452 may be integrally formed using the same material. For example, the body portion 453 and the first and second connecting portions 451 and 452 may be made of a metal having conductivity. Here, the metal may include copper, aluminum or the like. The body portion 453 may be forcibly inserted into the space portion 433 of the top portion 430 made of the insulator. Thus, the body portion 453 is protected by the top portion 430, so that a separate insulator can be omitted. In addition, the body portion 453 is fixed by the top portion 430, so that the top portion 430 can be mounted on the battery case, and at the same time, the first and second connecting portions 451 and 452 can be coupled to the respective first and second terminal portions 421 and 422.

A first fastening portion 434 may be provided to the flange portion 432 of the top portion 430, and a second fastening portion 411 fastened to the first fastening portion 434 may be provided to the battery case 410. For example, the first and second fastening portions 434 and 411 may include an adhesive member, groove-projection coupling, hook coupling or surface roughness. In this embodiment, the first and second fastening portions 434 and 411 are formed to have surface roughness. After the battery case 410 is inserted into the top portion 430, the frictional force between the first and second fastening portions 434 and 411 increases, so that the top portion 430 can be firmly fixed to the battery case 410. Like the secondary battery of the aforementioned embodiment, the manufacturing of the secondary battery 400 according to this embodiment is completed by omitting formation. The secondary battery 400 may have a voltage of −0.1V to 0.1V.

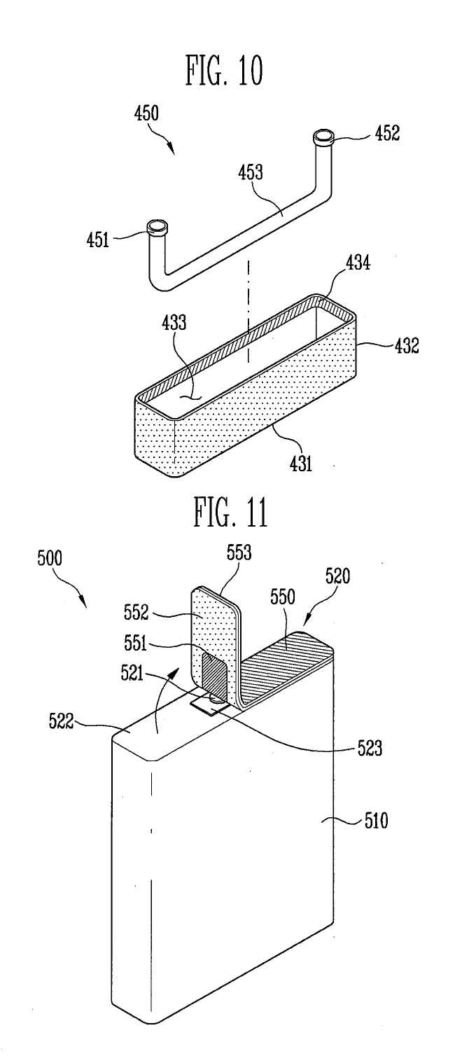

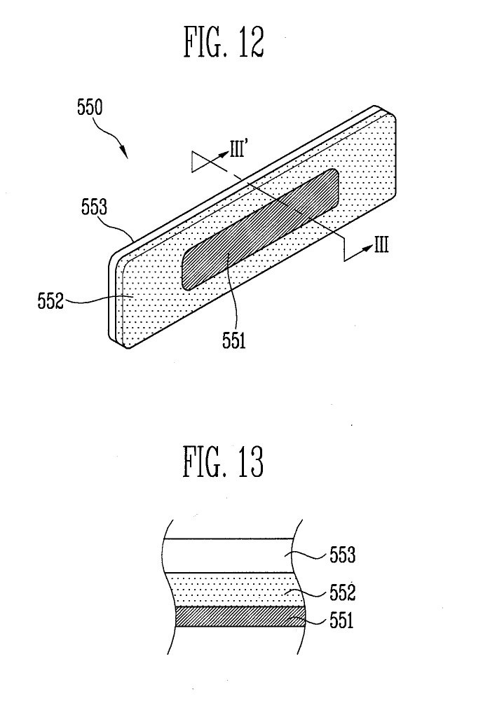

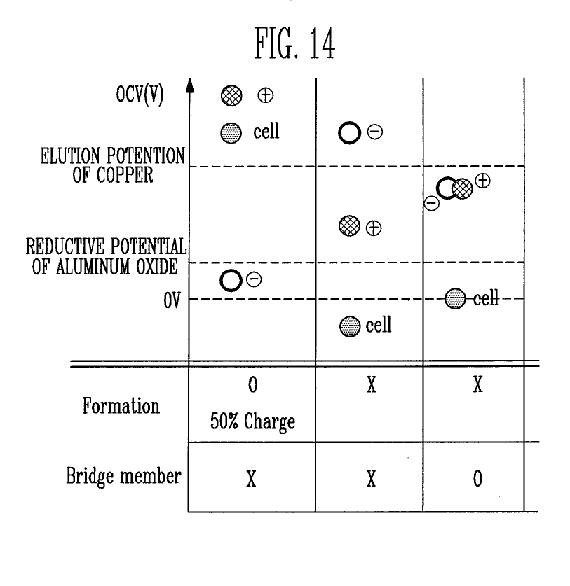

FIG. 11 is a perspective view of a secondary battery according to still another embodiment of the present invention. FIG. 12 is a perspective view of a bridge member of FIG. 11. FIG. 13 is a sectional view taken along the line of the bridge member of FIG. 12.

Referring to FIGS. 11 to 13, the secondary battery 500 according to this embodiment may include a battery case 510 and 520 and an electrode assembly accommodated inside the battery case 510 and 520, and a bridge member 550 may be provided at the outside of the battery case 510 and 520. The secondary battery 500 may be provided with first and second terminal portions 521 and 522 having different polarities, and the first and second terminal portions 521 and 522 may be insulated from each other by a gasket 523. The first and second terminal portions 521 and 522 may be electrically coupled by the bridge member 550.

The bridge member 550 is formed by sequentially laminating, in a sheet shape, a metal portion 551, an adhesive portion 522 and a resin portion 553, and the metal portion 551 may be provided to have an area smaller than that of each of the adhesive potion 552 and the resin portion 553. The metal portion 551 may couple the terminal portions 521 and 522 having different polarities at the outside of the battery case 510 and 520, and the adhesive portion 552 may be attached to an outer surface of the battery case 510 and 520. That is, the bridge member 550 is provided so that the metal portion 551 covers both the first and second terminal portions 521 and 522. The bridge member 550 is stably fixed by the adhesive portion 552, and can be protected by the resin portion 553. The manufacturing of the secondary battery 500 according to this embodiment is completed by omitting formation, and therefore, an SEI film may not be formed on the first or second electrode plate constituting the electrode assembly. Because the secondary battery 500 is released in a state in which the secondary battery 500 is not charged, the voltage of the secondary battery 500 may be −0.1V to 0.1V.

Hereinafter, an embodiment of the present invention and a comparative example will be described. However, the following embodiment is merely one embodiment, and the scope of the present invention is not limited to the following embodiment.

A secondary battery according to an embodiment of the present invention was manufactured according to FIGS. 1 to 5 described above. In the secondary battery, a first electrode plate was provided as a positive electrode formed by coating a first active material including a lithium compound on a first base material, and a second electrode plate was provided as a negative electrode plate formed by coating a second active material including carbon on a second base material. An electrode assembly was formed by winding or rolling the first and second electrode plates and a separator. Then, the electrode assembly and an electrolyte were accommodated inside a housing, and the housing was hermetically sealed with a cap assembly. In the first electrode plate, an aluminum base material was used as the first base material. In the second electrode plate, a copper base material was used as the second base material. A bridge member was provided so that first and second connecting portions of the bridge member were welded to a top of the cap assembly. After the assembling of the secondary battery according to this embodiment was completed, additional formation was not performed.

A secondary battery according to a comparative example was manufactured using first and second electrode plates, a battery case and an electrolyte, which were identical to those of the embodiment, except that the bridge member was provided in the embodiment. As shown in FIG. 14, according to a first group, formation was performed in a case where the secondary battery according to the comparative example was charged by 50% after the assembling of the secondary battery was completed. According to a second group, the formation was omitted after the assembling of the secondary battery was completed. Both the secondary batteries according to the first and second groups were not provided with the bridge member.

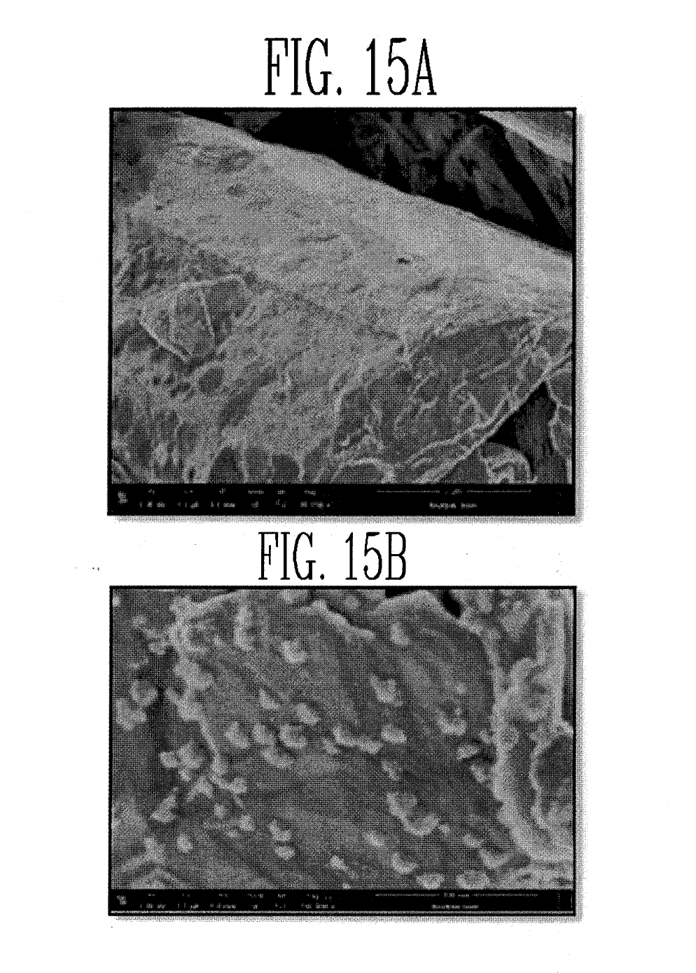

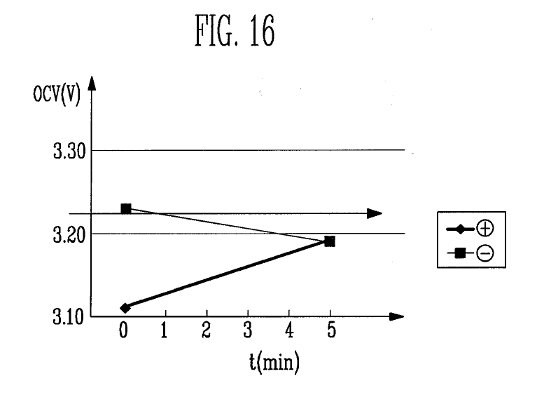

FIG. 14 is a graph showing potentials of first and second electrode plates and secondary batteries. FIG. 15A is a scanning electron microscope (SEM) photograph of the second electrode plate according to the embodiment of the present invention. FIG. 15B is an SEM photograph of the second electrode plate according to the comparative example.

Referring to the graph of FIG. 14, in the first group of the comparative example, in which the formation was performed on the secondary battery charged by 50% and the bridge member was not provided, the potential of the first electrode plates (positive electrode, +) was higher than the elution potential of copper, and the potential of the second electrode plate (negative electrode, −) was lower than the reductive potential of aluminum oxide. Thus, the copper in the second electrode plate is not eluted into the electrolyte, and accordingly, it is possible to prevent or reduce corrosion or the like. In addition, the formation was performed on the secondary battery (cell) according to the first group, and therefore, the potential of the secondary battery was lower than that of the first electrode plate. On the other hand, according to the second group of the comparative example, in which the formation was not performed and the bridge member was not provided, the potential of the first electrode plate (positive electrode, +) was higher than the reductive potential of the aluminum oxide, and the potential of the second electrode plate (negative electrode, −) was higher than the elution potential of the copper.

In addition, the potential of the second battery (cell) according to the second group was lower than that of the first electrode plate, which was much lower than 0V. Therefore, in the second battery according to the second group, the copper in the second electrode plate was eluted into the electrolyte, and the second electrode plate was corroded. In the secondary battery according to this embodiment, the formation was not performed, and the bridge member was provided. The potential of the first electrode plate (positive electrode, +) was higher than the reductive potential of the aluminum oxide, and the potential of the second electrode plate (negative electrode, −) was lower than the elution potential of the copper. In addition, the formation was not performed on the secondary battery according to this embodiment, and therefore, the potential of the secondary battery was 0V, but was not much lower than 0V, like the second group.

That is, according to the second group, the copper in the second electrode plate is eluted, and therefore, the potential of the secondary battery is gradually decreased. However, in this embodiment, the potential of the first electrode plate is maintained higher than the reductive potential of the aluminum oxide, and the potential of the second electrode plate is maintained lower than the elution potential of the copper, so that it is possible to prevent the elution of the copper in the second electrode plate.

Accordingly, the potential of the secondary battery can be maintained without being decreased below 0V. The secondary battery according to this embodiment has the bridge member, so that an external short circuit is induced at the outside of the secondary battery. Thus, the potential of the first electrode plate of the secondary battery is maintained higher than the reductive potential of the aluminum oxide (e.g., about 2.0V, based on lithium), and the potential of the second electrode of the secondary battery is maintained lower than the elution potential of the copper (e.g., about 3.3V, based on lithium), so that it is possible to prevent or reduce the elution of the copper in the second electrode plate on which the SEI film is not formed by omitting the formation. That is, in a case where the first base material is aluminum, the potential of the first electrode plate may be no less than the reductive potential of the aluminum oxide. In a case where the second base material is copper, the potential of the second electrode plate may be no more than the elution potential of the copper. In addition, the potential of the first electrode plate is no less than 2.0V which is the reductive potential of the aluminum oxide, based on the lithium, and the potential of the second electrode plate is no more than 3.3V which is the elution optional of the copper, based on the lithium.

In FIGS. 15A and 15B, FIG. 15A shows a surface of the second electrode plate of the secondary battery according to this embodiment, on which the formation is not performed, and FIG. 15B shows a surface of the second electrode plate of the secondary battery according to the first group of the comparative example, on which the formation is performed. It can be seen that the surface of the second electrode plate of the secondary battery according to this embodiment is different from that of the second electrode plate of the secondary battery according to the first group of the comparative example.

While the second electrode plate according to this embodiment is formed to have a surface absorbed onto the surface of a negative electrode active material that is the second active material, the second electrode plate according to the first group of the comparative example is formed to have a surface formed by absorbing particles of a material, together with a film obtained by changing the material, onto the surface of a negative electrode material that is the second active material. This is a result from an SEI film formed through a reaction between the second active material of the second electrode plate and the electrolyte when the formation is performed. It can be seen that the surface of the second electrode plate, on which the SEI film is not formed in FIG. 15a, is different from that of the second electrode plate, on which the SEI film is formed in FIG. 15B.

Thus, in the secondary battery according to this embodiment, the formation is omitted, and the surface of the negative electrode active material which is the second active material of the second electrode plate comes in direct contact with the separator in the state in which the SEI film is not formed on the second electrode plate.

FIG. 16 is a graph showing open circuit voltages (OCVs) of the first and second electrode plates of the secondary battery with respect to time according to the embodiment of the present invention.

FIG. 16 shows a change in OCV of each of the first electrode plate (+) and the second electrode plate (−) with respect to time in the secondary battery manufactured according to this embodiment. In FIG. 16, the arrow indicates the elution potential of copper. Because an external short circuit of the secondary battery is induced by the bridge member, the OCV of each of the first and second electrode plates is changed depending on time. That is, it can be seen that, as time elapses, the OCV of the first electrode plate increases, and the OCV of the second electrode plate decreases. As a result, it can be seen that the OCV of each of the first and second electrode plates is converged to about 3.2V or less. That is, the potential of the first electrode plate is no less than 2.0V, and the potential of the second electrode plate is no more than 3.3V.

As a result obtained by analyzing the electrolyte through the disassembling of the secondary battery according to this embodiment, it can be seen that the copper in the second electrode plate is not eluted, and it can be seen that the first and second base materials (aluminum and copper base materials) constituting the respective first and second electrode plates are not corroded. In addition, it can be seen that when being mounted to an external electronic device and then initially charged, the secondary battery according to this embodiment has performance similar to that of the secondary battery according to the first group of the comparative example.

Because the manufacturing of the secondary battery can be completed without performing the existing formation, time required in the formation, some additional equipment and facilities including charging/discharging devices, or storage may not be required. Accordingly, it is possible to reduce the manufacturing time of the secondary battery and to improve the process efficiency of the secondary battery by reducing the production cost of the secondary battery.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims, and their equivalents.

What is claimed is:

1. A secondary battery, comprising:
an electrolyte;
an electrode assembly comprising:
a first electrode plate comprising a first active material on a first base material,
a second electrode plate opposite to the first electrode plate and comprising a second active material on a second base material, and
a separator between the first and second electrode plates;
a battery case accommodating the electrode assembly and the electrolyte; and
a bridge member coupled between terminal portions having different polarities at the outside of the battery case,
wherein a voltage of the secondary battery is in a range of −0.1V to 0.1V.

2. The secondary battery of claim 1, wherein the first base material comprises aluminum, and a potential of the first electrode plate is no less than a reductive potential of aluminum oxide.

3. The secondary battery of claim 2, wherein the potential of the first electrode plate is no less than 2.0V, and the potential of the second electrode plate is no more than 3.3V.

4. The secondary battery of claim 1, wherein the second base material comprises copper, and a potential of the second electrode plate is no more than an elution potential of the copper.

5. The secondary battery of claim 1, wherein the first electrode plate has a first electrode tab, and the second electrode plate has a second electrode tab, and
wherein the first and second electrode tabs extend outside the electrode assembly.

6. The secondary battery of claim 5, wherein the first and second electrode tabs extend in parallel to each other from the electrode assembly to outside of the battery case, and
wherein the bridge member has first and second connecting portions respectively coupled to the first and second electrode tabs.

7. The secondary battery of claim 5, wherein the battery case comprises a first terminal portion electrically coupled to the first electrode tab, and a second terminal portion electrically coupled to the second electrode tab, the second terminal portion being electrically insulated within the battery case from the first terminal portion, and
wherein the bridge member has first and second connecting portions respectively coupled to the first and second terminal portions.

8. The secondary battery of claim 7, wherein the bridge member comprises the first and second connecting portions, and a body portion configured to couple the first and second connecting portions therethrough.

9. The secondary battery of claim 8, wherein the body portion comprises a conducting portion electrically coupled to the first and second connecting portions, and an insulating portion around the conducting portion.

10. The secondary battery of claim 9, wherein the first and second connecting portions and the conducting portion comprise copper or aluminum.

11. The secondary battery of claim 8, wherein the battery case comprises a housing configured to accommodate the electrode assembly and the electrolyte through one opened surface thereof, and a cap assembly configured to cover the one opened surface of the housing.

12. The secondary battery of claim 11, further comprising a top portion mounted on the cap assembly and configured to surround the bridge member.

13. The secondary battery of claim 12, wherein the top portion comprises a base portion formed in a shape corresponding to the cap assembly, and a flange portion extended toward the cap assembly from an outer circumference of the base portion.

14. The secondary battery of claim 13, wherein the top portion has a cavity defined by the base portion and the flange portion, and the bridge member is inserted into the cavity.

15. The secondary battery of claim 14, wherein the bridge member comprises a body portion formed in a reverse U shape, and first and second connecting portions respectively located at opposite ends of the reverse U shape.

16. The secondary battery of claim 15, wherein the top portion is made of an insulator, and the body portion is made of a conductor to be inserted into the cavity of the top portion.

17. The secondary battery of claim 13, wherein the flange portion comprises a first fastening portion, and the battery case comprises a second fastening portion configured to be coupled to the first fastening portion.

18. The secondary battery of claim 1, wherein the bridge member comprises sequentially laminated conductive, adhesive, and resin layers, and
wherein the conductive layer has an area smaller than that of each of the adhesive and resin layers.

19. The secondary battery of claim 18, wherein the conductive layer couples terminal portions having different polarities at the outside of the battery case, and the adhesive layer is attached to an outer surface of the battery case.

20. The secondary battery of claim 1, wherein a shape of the bridge member is elastically changeable.
